(19) United States
(12) Patent Application Publication
(10) Pub. No.: US 2007/0226144 A1
(43) Pub. Date: Sep. 27, 2007

(54) Method and apparatus to record usage of a portable media

(75) Inventor: Shin Cheung Simon Chiu, Palo Alto, CA (US)

Correspondence Address: FERNANDEZ & ASSOCIATES LLP, 1047 EL CAMINO REAL, SUITE 201, MENLO PARK, CA, 94025, US

(73) Assignee: TP Lab, Palo Alto, CA (US)

(21) Appl. No.: 11/388,832

(22) Filed: Mar. 24, 2006

(51) Int. Cl. H04L 9/00

(52) U.S. Cl. 705/51

(57) ABSTRACT

A method and system for providing a media to keep a record of its usage, and for the record to belong to the user of the media, are disclosed. The media includes a media content, and a media content processor for retrieving the media content in response to a media content retrieval request. The method and system further includes a usage record for storing at least one media usage record, where the media usage record comprises information about the media content retrieval request. The usage record belongs to a user of the media, where the user directly accesses the usage record via a usage record retrieval request for retrieving information from the usage record. The processing of the media content retrieval request and the usage record retrieval request are performed in separate transactions.

### BACKGROUND

1. Field

This invention relates generally to media, and more specifically to a method and apparatus to process a media with a usage record.

2. Related Art

Usage of portable media is becoming popular. People carry credit cards, gift cards, prepaid phone cards, digital music players, medical cards, identity cards, or employee cards. Each card is a media containing useful content for specific purposes. People use these cards frequently. John had a gift card of $200 value for a department store. He went to shop at the department store. He bought a tie, a pair of shoes, and a cup of coffee. The next day, he went and bought a shirt, a pair of ear-ring for his wife, a cup of coffee and a coffee pot. He lost a few receipts. A month later, John wanted to know what he bought at the department store. He could not find all the receipts. He had the gift card but did not know the remaining amount because the record for the gift card belongs to the department store, and John does not have access to this record.

Mary bought an electronic book for her daughter Jane. On and off, Jane read the electronic book. Mary wants to know if Jane has been reading, when, the progress and for how long. The electronic book does not keep a record of how it was read by Jane.

The above illustrates a need for a media to keep a record of its usage and for the record to belong to the user.

### SUMMARY

A method and system for providing a media to keep a record of its usage, and for the record to belong to the user of the media, are disclosed. The media includes a media content, and a media content processor for retrieving the media content in response to a media content retrieval request. The method and system further includes a usage record for storing at least one media usage record, where the media usage record comprises information about the media content retrieval request. The usage record belongs to a user of the media, where the user directly accesses the usage record via a usage record retrieval request for retrieving information from the usage record. The processing of the media content retrieval request and the usage record retrieval request are performed in separate transactions.

### BRIEF DESCRIPTION OF DRAWINGS

FIG. 1 illustrates a media in accordance with the present invention.

FIG. 2 illustrates a cash card in accordance with the present invention.

FIG. 3 illustrates a process to reduce cash value.

FIG. 4 illustrates a process to increase cash value.

FIG. 5 illustrates an embodiment of using a cash card.

### DETAILED DESCRIPTION

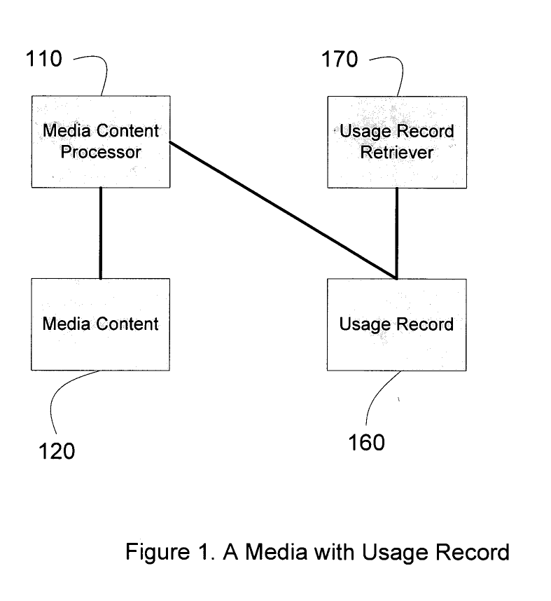

FIG. 1 illustrates a media in accordance with the present invention.

A media includes media content 120. In one embodiment, media content 120 represents a monetary value. A media is a gift certificate, a money card, or a money card from a retail store.

In one embodiment, media content 120 includes audio content, such as a song, a speech, recorded sound, or audio clip. In one embodiment, media content 120 includes video content, such as a movie, an animation clip, a video clip, a television program recording, or a video recording. In one embodiment, media content 120 includes a live concert, televised sport event, live news broadcast. In one embodiment, media content 120 includes an article, such as a book, a piece of news, written paper, spreadsheet, or presentation slides. In one embodiment, media content 120 includes a picture, such as a photo, graphical image, graph, or table.

A media includes media content processor 110. In one embodiment, media content processor 110 processes a request to retrieve media content 120. Media content processor 110 retrieves media content 120. Media content processor 110 receives a media content retrieval request and replies to the request by retrieving the retrieved media content. In one embodiment, the media content retrieval request includes additional information. In one scenario, additional information includes time information; requester information, such as a merchant identity; or transaction information, such as debit amount, or media content usage duration. Media content processor 110 processes retrieved media content based on the addition information. Media content processor 110 replies to the media content retrieval request with the processed retrieved media content. In one embodiment, media content processor 110 modifies media content 120 after the retrieval. In an embodiment, media content processor 110 updates media content 120 with the processed retrieved media content.

Usage record 160 includes a plurality of media usage records. In one embodiment, the media includes the usage record 160. In another embodiment, the usage record 160 is external to the media.

Media content processor 110 stores media usage record to usage record 160. Media usage record includes information about a media content retrieval request. In one embodiment, media usage record includes time information, additional information included in the media content retrieval request, retrieved media content information, or processed retrieved media content information. The usage record 160 belongs to the user, where the retrieval of the usage record 160 is directly requested by the user.

In one embodiment, a media includes usage record retriever 170. Usage record retriever 170 processes a request to retrieve usage record 160. Usage record retriever 170 retrieves usage record 160. Usage record retriever 170 replies to the usage record retrieval request with the retrieved information from usage record 160. The retrieval of the usage record is independent of the retrieval of the media content 120 per a media content retrieval request.

In one embodiment, a usage record retrieval request requests for all media usage records. Usage record retriever 170 retrieves all media usage records in usage record 160, and replies to the usage record retrieval request with the retrieved media usage records.

In one embodiment, a usage record retrieval request requests for a media usage record. In a scenario, usage record retrieval request requests for the latest media usage record. Usage record retriever 170 obtains the latest media usage record from usage record 160.

In a scenario, usage record retrieval request requests for the first media usage record. Usage record retriever 170 obtains the first media usage record from usage record 160.

In a scenario, a usage record retrieval request requests for the next media usage record. Usage record retriever 170 includes a memory storing an identity of the last media usage record retrieved. Usage record retriever 170 obtains the next media usage record from usage record 160, based on the stored identity.

In one embodiment, a media usage record includes a key. A usage record retrieval request includes a request key. Usage record retriever 170 matches the request key with usage record 160, and retrieves a plurality of media usage records matching the request key.

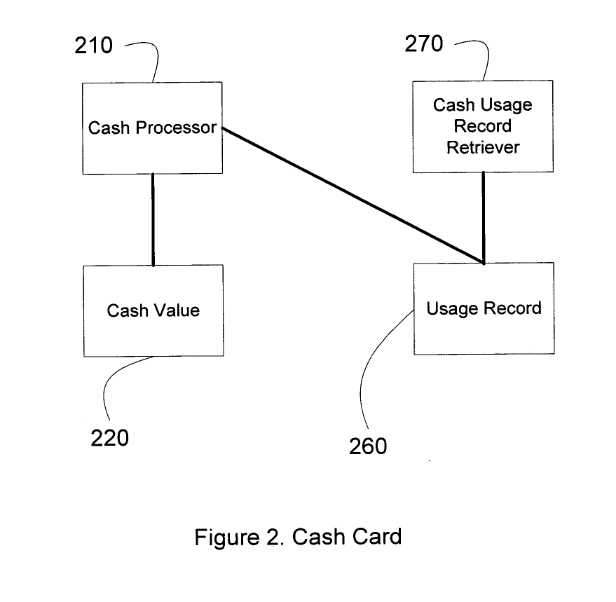

FIG. 2 illustrates a cash card. A cash card is a media. A cash card includes a cash value 220. Cash value 220 is a media content. In one embodiment, cash value 220 includes a number representing a monetary amount. In another embodiment, cash value 220 includes an identity. The identity can be a number, a sequence of alphabets and digits, or a name. The identity can be used to relate to a monetary amount.

A cash card includes a cash processor 210. Cash processor 210 is a media content processor. Cash processor 210 processes a cash query about cash value 220. In one embodiment, a cash query is to retrieve cash value 220, to reduce cash value 220, or to increase cash value 220. Cash processor 210 retrieves cash value 220 and processes the cash query based on the retrieved cash value.

Cash processor 210 stores to usage record 260 cash usage record. A cash usage record is a media usage record. In one embodiment, a cash usage record includes a time, the retrieved cash value, the processed cash value, or the amount of cash value changed. In one embodiment, the cash query includes additional information such as merchant information, bank information, merchandize information, or user information. Cash usage record includes the additional information to usage record 260.

Usage record 260 includes a plurality of cash usage records. In one embodiment, the media includes the usage record 260. In another embodiment, the usage record 260 is external to the media.

In one embodiment, a cash card includes cash usage record retriever 270. A cash usage record retriever 270 is a usage record retriever. The usage record 260 belongs to the user, where the retrieval of the usage record 260 is directly requested by the user.

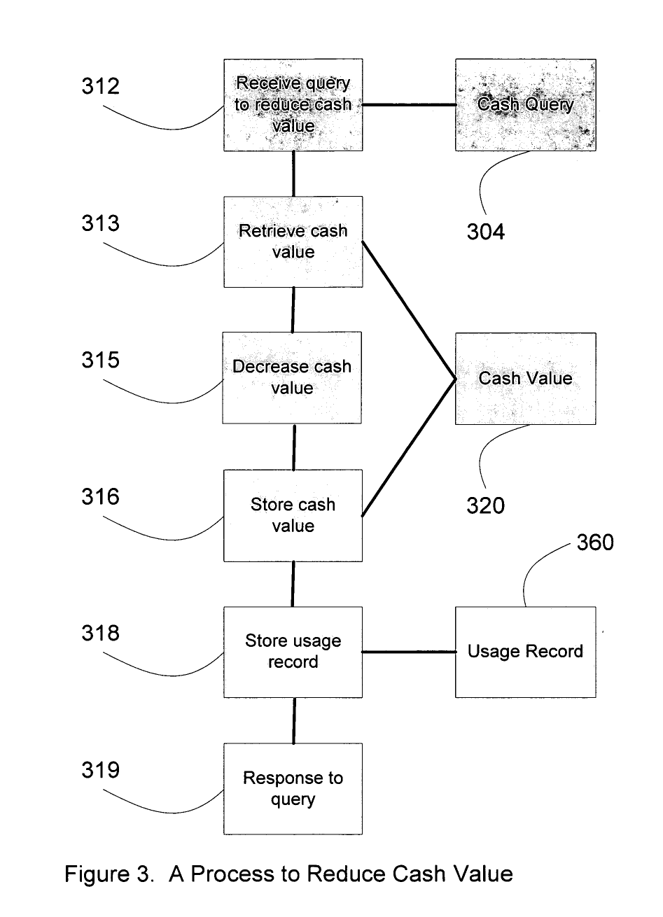

FIG. 3 illustrates a process to reduce cash value. In one embodiment, a cash processor processes a cash query to reduce cash value. The process of cash processor includes a plurality of steps illustrated in FIG. 3.

In step 312, cash processor receives a cash query 304 to reduce cash value. Cash query 304 includes the reduction amount. In one embodiment, cash query 304 includes additional information. In a scenario, the additional information includes time, time of transaction, merchandize or product information, merchant information, buyer information, bank information, institution information, or transaction authorization information.

In step 313, cash processor retrieves cash value from cash value 320.

In step 315, cash processor subtracts the reduction amount from the retrieved cash value. Cash processor generates a reduced cash value from the subtraction. In one embodiment, cash processor determines the retrieved cash value is larger than or equal to the reduction amount before the subtraction. In step 316, cash processor stores into cash value 320 with the reduced cash value. Cash processor generates a cash usage record. The cash usage record includes information related to cash query 304. In one embodiment, the cash usage record includes the reduction amount, or reduced cash value. In another embodiment, the cash usage record includes the additional information in cash query 304. In a different embodiment, cash usage record includes the current time. Cash processor stores, in step 318, cash usage record in usage record 360.

In step 319, cash processor responses to cash query 304. In a scenario, the response from cash processor includes the reduced cash value. In another scenario, the response is an indication of the completion of the reduction of cash value 320.

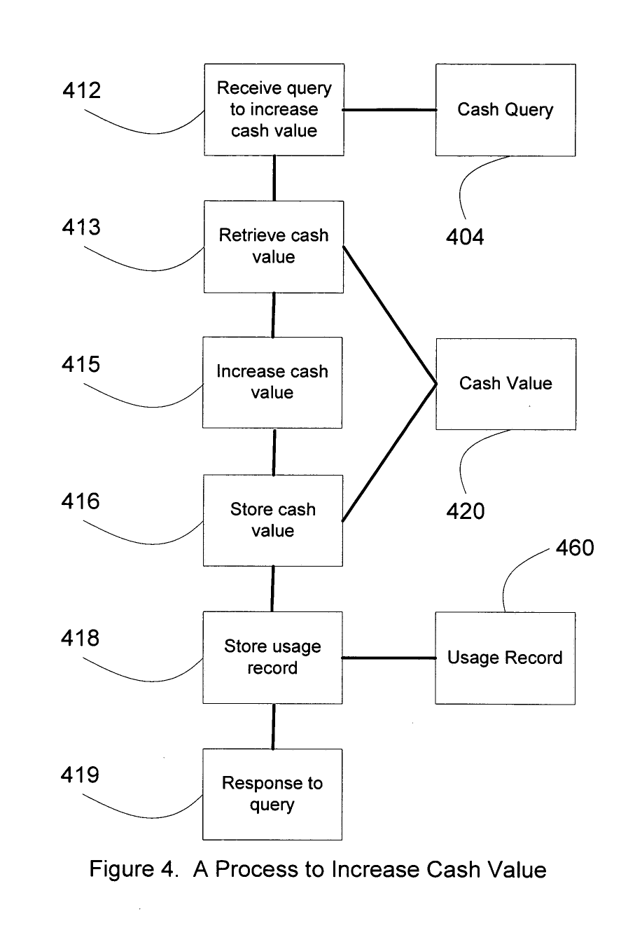

FIG. 4 illustrates a process to increase cash value. In one embodiment, a cash value processor processes a cash query to increase cash value. The process of cash processor includes a plurality of steps illustrated in FIG. 4.

In step 412, cash processor receives a cash query 404 to increase cash value. Cash query 404 includes the increment amount. In one embodiment, cash query 404 includes additional information. In a scenario, the addition information includes time, time of transaction, merchandize or product information, merchant information, buyer information, bank information, institution information, or transaction authorization information.

In step 413, cash processor retrieves cash value from cash value 420.

In step 415, cash processor adds the increment amount to the retrieved cash value. Cash processor generates an incremented cash value from the addition. In step 417, cash processor stores into cash value 420 with the incremented cash value. Cash processor generates a cash usage record. The cash usage record includes information related to cash query 404. In one embodiment, the cash usage record includes the increment amount, or incremented cash value. In another embodiment, the cash usage record includes the additional information in cash query 404. In a different embodiment, cash usage record includes the current time. In step 418 Cash processor stores the cash usage record in usage record 460.

In step 419, cash processor responses to cash query 404. In a scenario, the response from cash processor includes the reduced cash value. In another scenario, the response is an indication of the completion of the reduction of cash value 420.

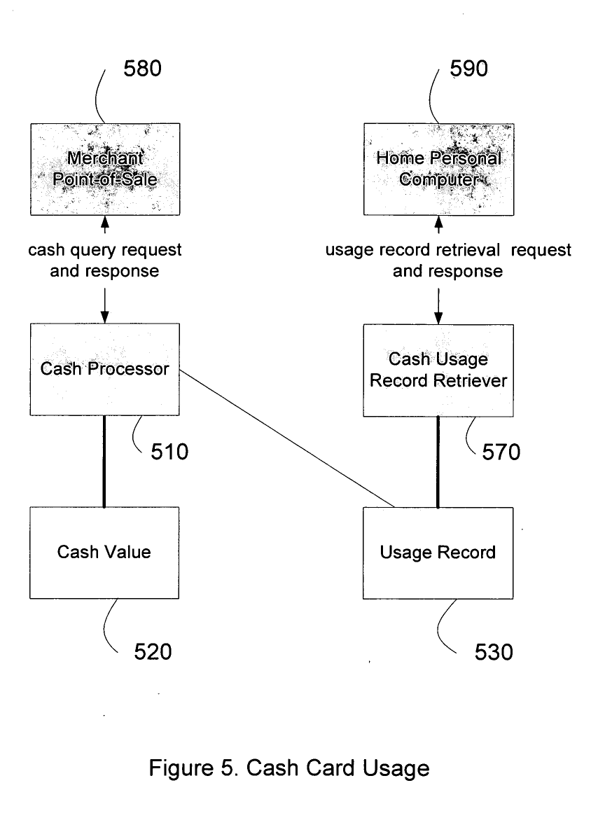

FIG. 5 illustrates an embodiment of using a cash card.

A user uses a cash card to pay for a purchase.

The cash card includes cash processor 510, cash value 520, usage record 530 and cash usage record retriever 570.

The cash card includes a storage, such as a magnetic tape, a flash random access memory, a mini drive, a random access memory powered by an associated battery, or a Non-Volatile Random Access Memory (NVRAM), such as a Magnetoresistive Random Access Memory (MRAM) or a carbon nanotubes memory. Usage Record 530 resides in the storage.

The cash card connects to a merchant point-of-sale 580. Merchant point-of-sale 580 includes a merchant card reader that accepts the cash card. The user puts the cash card in the merchant card reader. Cash processor 510 receives a cash query request from merchant point-of-sale 580. Cash processor 510 processes the cash query request by retrieving cash value 520; reducing cash value 520 based on the monetary amount of the purchase; generates and stores a cash usage record in usage record 530 as illustrated in FIG. 3. In one embodiment, merchant point-of-sale 580 includes an electronic funds transfer module that uses the response of the cash query request to complete an electronic fund transfer transaction.

A user uses a home personal computer 590 to read the cash card. Home personal computer 590 connects to a personal card reader that accepts the cash card. Home personal computer 590 includes an application that processes cash usage record. The user puts the cash card in the personal card reader.

Cash usage record retriever 570 receives a usage record retrieval request from home personal computer 590 over the personal card reader. Cash usage record retriever 570 retrieves the cash usage record from usage record 530 and returns the cash usage record to home personal computer 590.

Home personal computer 590 receives the cash usage record. The application displays information based on the cash usage record on a graphic display screen connected to home Personal computer 590 or prints the information to a printer connected to home personal computer 590.

In one embodiment, a cash card can be used as a gift card, a money card, a bank account card for banking accounts such as saving accounts and certificates of deposit, a food stamp card, or a debit card. Cash usage records stored in the cash card can be retrieved for further processing. In one scenario, a company gives a debit card to a traveling worker. The worker returns the debit card to the company after the trip. The company generates a traveling expense report based on the usage record in the debit card.

In one scenario, a mother gives a cash card to her son studying in a college. At the end of each week, the mother retrieves the usage record of the cash card, and checks if her son uses the cash for abnormal purchases such as alcohol purchase, expensive item purchase.

Foregoing described embodiments of the invention are provided as illustrations and descriptions. They are not intended to limit the invention to precise form described. In particular, it is contemplated that functional implementation of invention described herein may be implemented equivalently in hardware, software, firmware, and/or other available functional components or building blocks, and that networks may be wired, wireless, or a combination of wired and wireless. Other variations and embodiments are possible in light of above teachings, and it is thus intended that the scope of invention not be limited by this Detailed Description, but rather by Claims following.

We claim:

1. A system, comprising:
a media, comprising:
a media content, and
a media content processor for retrieving the media content in response to a media content retrieval request; and
a usage record for storing at least one media usage record, wherein the media usage record comprises information about the media content retrieval request, wherein the usage record belongs to a user of the media.

2. The system of claim 1, wherein the media content comprises at least one of the following: audio content, video content, live broadcast, article, or picture.

3. The system of claim 1, wherein the media content retrieval request comprises additional information, wherein the media content processor retrieves the media content based on the additional information.

4. The system of claim 1, wherein the media comprises the usage record.

5. The system of claim 1, wherein the usage record resides externally to the media.

6. The system of claim 1, further comprising:
a usage record retriever for retrieving the usage record in response to a usage record retrieval request.

7. The system of claim 6, wherein the usage record retriever:
receives a usage record retrieval request;
retrieves the usage record; and
replies to the usage record retrieval request with information from the retrieved usage record.

8. The system of claim 6, wherein the usage record retrieval request comprises at least one of the following:
a request for all media usage records;
a request for a latest media usage record;
a request for a first media usage record;
a request for a next media usage record; and
a request for a media usage record including a key.

9. The system of claim 6, wherein the media comprises the usage record retriever.

10. The system of claim 6, wherein the usage record retriever resides externally to the media.

11. The system of claim 6, wherein the usage record belongs to the user of the media, wherein the user directly accesses the usage record via the usage record retrieval request.

12. The system of claim 6, wherein a processing of the usage record retrieval request is performed in a separate transaction from a processing of the media content retrieval request.

13. The system of claim 1, wherein the media comprises a cash card,
wherein the media content comprises a cash value,
wherein the media content retrieval request comprises retrieving a cash value, reducing the cash value, or increasing the cash value,
wherein the media usage record comprises a time, a retrieved cash value, a processed value, or an amount cash value changed.

14. A method for providing record usage of a media, comprising the steps of:
(a) providing a media comprising a media content;
(b) retrieving the media content in response to a media content retrieval request; and
(c) storing a media usage record in a usage record, wherein the media usage record comprises information about the media content retrieval request, wherein the usage record belongs to a user of the media.

15. The method of claim 14, wherein the media content comprises at least one of the following: audio content, video content, live broadcast, article, or picture.

16. The method of claim 14, wherein the media content retrieval request comprises additional information, wherein the media content is retrieved based on the additional information.

17. The method of claim 14, further comprising:
(d) processing a usage record retrieval request to retrieve information from the usage record.

18. The method of claim 17, wherein the processing step (d) comprises:
(d1) receiving a usage record retrieval request;
(d2) retrieving the usage record; and
(d3) replying to the usage record retrieval request with information from the retrieved usage record.

19. The method of claim 17, wherein the usage record retrieval request comprises at least one of the following:
a request for all media usage records;
a request for a latest media usage record;
a request for a first media usage record;
a request for a next media usage record; and
a request for a media usage record including a key.

20. The method of claim 17, wherein the usage record belongs to the user of the media, wherein the user directly accesses the usage record via the usage record retrieval request.

21. The method of claim 17, wherein the processing of the usage record retrieval request is performed in a separate transaction from a processing of the media content retrieval request.

22. The method of claim 14, wherein the media comprises a cash card,
wherein the media content comprises a cash value,
wherein the media content retrieval request comprises retrieving a cash value, reducing the cash value, or increasing the cash value,
wherein the media usage record comprises a time, a retrieved cash value, a processed value, or an amount cash value changed.
